(19) United States
(12) Patent Application Publication
(10) Pub. No.: US 2008/0193611 A1
(43) Pub. Date: Aug. 14, 2008

(54) FOOD PRODUCT AND METHOD OF HEATING

(75) Inventor: Donald O. Raezler, Wheaton, IL (US)

Correspondence Address: HUSCH BLACKWELL SANDERS LLP, 720 OLIVE STREET, SUITE 2400, ST. LOUIS, MO, 63101, US

(73) Assignee: BAJA FOODS, LLC, Chicago, IL (US)

(21) Appl. No.: 12/026,624

(22) Filed: Feb. 6, 2008

Related U.S. Application Data
(60) Provisional application No. 60/889,663, filed on Feb. 13, 2007.

(51) Int. Cl. A21D 10/02

(52) U.S. Cl. 426/113; 426/523

(57) ABSTRACT

A food product having a soft starch based shell at least partially enclosing a filling forming a food component. A wrapper at least partially encloses the food component forming the food product. The food product is adapted for heating and holding on a roller grill without significant loss in quality.

### RELATED APPLICATIONS

This application is a non-provisional application claiming priority to provisional Patent Application Ser. No. 60/889,663 filed Feb. 13, 2007 the entire disclosure of which is incorporated herein by reference.

### BACKGROUND OF INVENTION

Food products utilizing a starch based soft shell to contain and support a filling are well known and numerous. Such food products include tamales, cannolis, burritos, enchiladas and corn dogs. Such foods may be savory or sweet and may be served in a variety of settings, although, they are often not as well adapted for reconstitution and serving in one setting as another type of setting, e.g., serving on a plate or as a finger food. For example, a tamale may be well adapted for serving on a plate or other dish, but, a traditional tamale, as served in the United States, is not well adapted for finger food use because of the fragility of the starch based shell typically because of a lack of cohesiveness in the shell. Additionally, such products are difficult to sell through certain types of ready to eat outlets, for example, snack bars, stadiums, and the like because they are difficult to heat and retain the integrity of the shell and thus the quality of the food product for an extended period of hold time in/on a heating device. Attempts have been made to resolve such issues, for example, by having the food static during heating, e.g. under infrared lights for long term heating but that preferentially heats one side of the food product and may lead to water/fat migration preferentially to one side of the food product. While such a heating method is desirable for maintaining structural integrity of the food product, the heating and liquid distribution may not be as uniform as when heated on a roller grill. Heating a tamale or other soft shell food on a roller grill can improve heating uniformity, but it has been found that rolling can adversely affect the structural quality of the food product by breaking down the shell and/or drying portions of the food product. Additionally, one may need to have a large quantity of products already hot to supply demand spikes in order to provide “fast food”. The long hold time heating problem solution is exacerbated by the need to have the food product as close to traditional in construction as possible. It is also desirable to have the food on display, particularly when heating, to induce sales. Thus, the problem is presented of providing a food product construction having a soft starch based shell that will retain the integrity of the food product during heating with a heating device that moves the product with the product being consumable as a finger food with uniform and good eating quality over extended periods of heating.

### SUMMARY OF INVENTION

The present invention involves the provision of a multi component food product having a starch based soft shell or casing at least partially enclosing a filling that can be based upon meat, vegetables, dairy products or a combination thereof. Sweet fillings may also be provided. The product is heatable on a rotary grill providing heat transfer to the food product preferably principally by conduction and/or radiation. The product is placed on the roller grill and is heated preferably by conduction from heat from the rollers on which the food product rests during movement during the heating process. The food product may be held on/in the heating device for an extended period of time without structural degradation or quality degradation of the food product.

### BRIEF DESCRIPTION OF DRAWINGS

FIG. 1 is a perspective view of a food product on a heating device.

FIG. 2 is a cross-sectional view of the food product on the heating device.

FIG. 3 is an exploded perspective view of the food product with wrapper.

Like numbers throughout the Figures designate like or similar parts and/or structure.

### DETAILED DESCRIPTION

The reference numeral 1 designates a packaged food product having a soft starch based shell 2 surrounding, at least partially, a filling 3 forming a food component 4. The packaged food product 1 includes the food component 4 and a wrapper designated generally 5 at least partially surrounding the food component 4 and preferably circumscribing the side perimeter or outer elongate side surface 7 of the food component 4 and providing a wrapper overlap area 6. The food product 1 is preferably heated on a heating device designated generally 10 that moves the food product 1 as by rotation during heating of the food product 1.

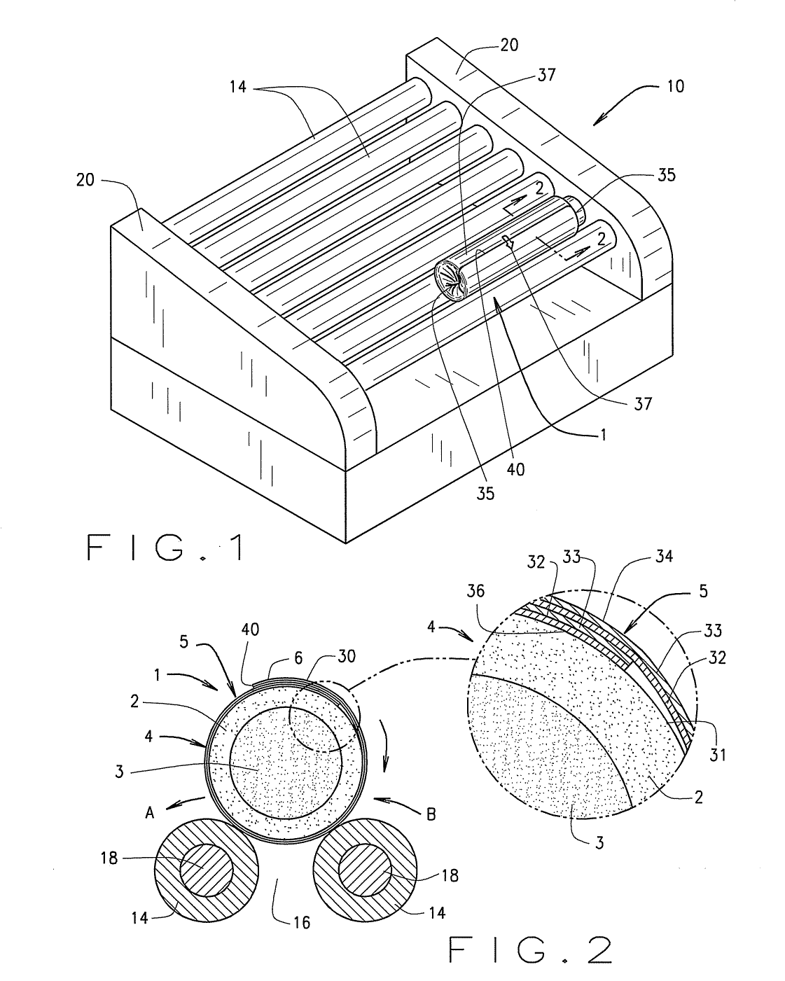

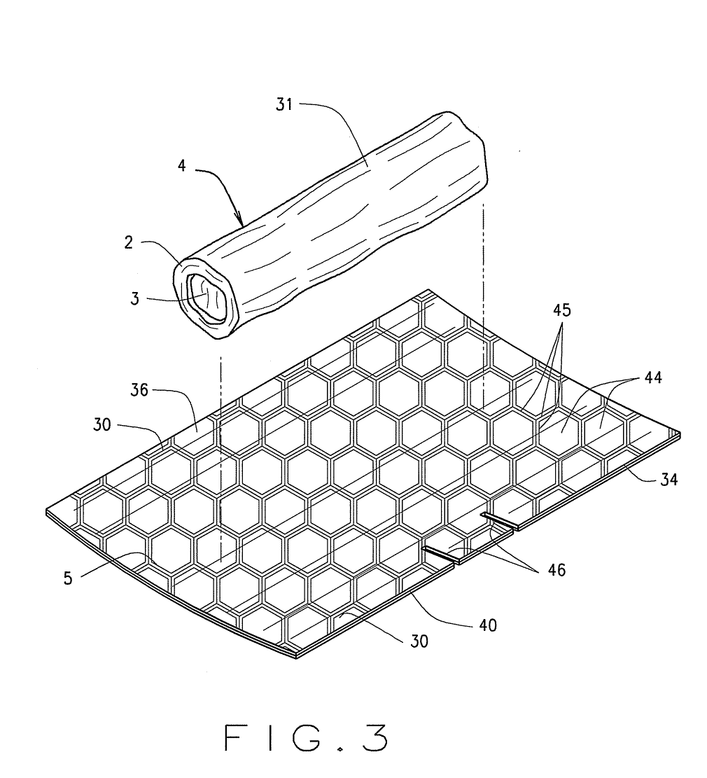

The cooking device 10 may be of any suitable kind and preferably provides heat to the food product 1 by at least conduction and/or radiation while effecting movement of the food product 1 preferably by rotating the food product about its longitudinal axis. Convection heating may also be used. In a preferred embodiment, the cooking device 10 is a roller grill that has heated rollers 14 that are power driven to effect rotation thereof. As seen in FIG. 2, immediately adjacent rollers 14 rotate in the same direction (arrows A, B) to effect rotation of the food product 1 thereon. One or more food products 1 rest on a pair of rollers 14 engaging an outer longitudinal surface 12 thereof. The cross sectional dimension and shape of a food product 1 is such as to prevent it from falling through the space 16 between adjacent rollers 14 while permitting rotation. While in the illustrated structure the rollers 14 have internal heaters 18, it is to be understood that radiant heat sources such as heat lights or convection heat sources such as hot air, can be used in place of or in combination with one or more of the three forms of heat transfer. As shown, the heating device 10 has a plurality of laterally spaced apart rollers 14 capable of supporting food products 1 between pairs of rollers 14. A power drive device, such as a motor (not shown), may be enclosed in one of the housings 20. Such roller grills are well known in the art.

The food product 1 includes a multi-component food 4 having an outer starch based soft shell or casing 2 at least partially enclosing the filling 3. As shown, the food product 1 has open ends whereby the opposite ends 22 of the filling 3 are exposed, but alternately, the ends 21 of the food 4 may be closed. Such a food product can include a tamale, cannoli, tortellini, corn dog, burrito, enchilada, wrap or the like. During heating of such food products and holding products for an extended period of time, e.g., hours, there are at least two potential modes of failure. One mode of failure is the shell 2 losing its integral structure or structural integrity. The second mode of failure is the loss of plasticizer, e.g., water. The shell 2 is starch based and will typically contain as major components of the particulate or comminuted material forming it, starch and protein. The comminuted material can be a grain based flour, e.g., cereal grain flour or flour from legumes (cereal grains and legumes are referred to collectively as “grain(s)” for convenience), like soybeans and combinations thereof as a majority of the flour. Cereal grains include wheat, corn, barley, triticale, rye, oats, etc. The flour component of the shell preferably includes at least a majority by weight of the shell of one grain, e.g., corn or wheat but can utilize blends to comprise the majority component by weight of the shell as cooked. Generally, the flour will include a protein component and a starch component. The shell 2 may be in the form of a cell structured or crumb structured product made from either a dough, e.g., masa, or a batter respectively. In the case of tamale shells made from masa, the masa may be considered an undeveloped dough containing the grain component and a plasticizing agent. In the case of batters and doughs (developed and undeveloped), the flour component has added thereto one or more plasticizing agents, including water and often times fat in various amounts and other well known ingredients. The starch containing dry comminuted component (the flour) is formed into a plasticized mass with the plasticizing agent and suitably mixed or developed as is known in the art. The plasticized mass is then formed into the appropriately sized and shaped product precursor or preform which may then be cooked. Also, particularly in the case of non-developed dough products, the shell 2 may be formed by extrusion or co-extrusion with a filling. Batter based products may be dipped to apply the batter. Generally, cooking of the precursor product gelatinizes the starch and sets the structure of the shell 2. Cooking may be by frying, baking or other suitable form of cooking. In the case of some dough products, particularly those containing gluten as a protein, the dough may be developed to the desired degree of development, if any. In the formation of a tamale type food component 4, the shell 2 may be extruded having the filling 3 co-extruded therewith. Cooling can occur in the extruder. As an alternate to extrusion or co-extrusion, the food component 4 may be formed by wrapping a shell 2 about an appropriate filling 3 forming at least some multi-layered shell overlap area. Such formation can be done by a machine or by hand, as desired. In the case of tamales, a masa flour is plasticized using water and other ingredients including flavorants as desired. Generally, a masa dough will contain about 25% to about 40% by weight (dry weight basis) masa flour and other grain based flour on a dry weight basis and about 15% to about 70% by weight total water. Other minor ingredients may be provided, e.g., fat and flavorants. The grain may contain fat naturally. Additionally, extra protein or other additives may be added to increase the strength of the shell 2. In a preferred embodiment, the shell 2 will comprise about 20% to about 70% by weight of the cooked food component 4, prior to reheating and have a thickness preferably in the range of between about 1/16″ to about ¼″ inch.

The filling 3, may comprise any suitable filling. Such fillings may include meat products such as beef, pork, poultry (such as chicken, turkey), fish or other aquatic life. The filling may also be comprised of vegetable product such as peppers, tomatoes, potatoes, onions, grain products for thickening, for example, starch and/or gum. The filling 3 may also include legumes, such as beans in whole or comminuted form. The filling 3 may also be comprised of dairy product e.g., cheese or cheese like filling. The filling 3 may also comprise egg products, for example egg yolk and/or egg white. Combinations of these ingredients may be provided. The filling 3 may be sweet, e.g., fruits, jellies, custards, etc. The filling 3 is preferably tolerant to long periods of exposure to heat while on the cooking apparatus 10. The filling 3 may be precooked if desired. The filling 3 has sufficient viscosity at the reheating hold temperature to retain the food component 4 in a self supporting manner and when heated will not flow out of the ends of the food component 4 if the filling 3 is left exposed to the environment. The filling 3 is shown as a single component but may include relatively distinct layers or segments. The filling 3 has an outer longitudinal side surface 25 and the ends 22. The surface 25 engages an inner surface 26 of the shell. The shell 2 has an outer longitudinal side surface 31 which engages the inner surface of the wrapper 5. Preferably the filling 3 and shell 2 are generally cylindrical on their exteriors.

The food product 1 includes a wrapper designated generally 5 overlying at least the outer side surface 31 of the shell 2 as best seen in the breakout of FIG. 2 and also folded around the ends of the food component 4. The wrapper 5 is preferably of a laminated structure comprising at least two layers including inner and outer layers 32, 33 respectively for a tamale product. A preferred wrapper for some products, e.g., a pizza product made with a leavened wheat-based shell may be a laminated quilted wrapper. In a preferred embodiment, the wrapper 5 has overlapping portions at 30 between opposite longitudinal side edge portions 34, 36 thereof and can overlap about ¼ to about ¾ of the perimeter of the side exterior of the shell 2. Preferably, the overlapping portions at 30 are not attached to one another.

In a preferred embodiment, the wrapper 5 has the inner and outer layers 32, 33 respectively, joined to one another, as by adhesion as with adhesive or an applied layer of bonding material such as polyethylene, forming a laminated structure or a foil honeycomb laminate having non-laminated and laminated areas forming air pockets. As seen in FIG. 3, the air pockets 44 are hexagonal with heat sealed areas 45 defining the pockets. Preferably, the inner layer is of a metal alloy film, e.g., aluminum alloy (herein aluminum foil for convenience) and the outer positioned layer 33 can be of a cellulosic or polymeric material. It has been found that a cellulosic material works well and is absorbent and porous. Preferably, two layers of paper are laminated together with a layer of polyethylene secured to an inner surface of or layer of paper. The inner layer 32 is preferably resistant to the penetration of plasticizer for example water and/or fat contained within the shell 2 and filling 3 reducing the need for coating or impregnating the layer 33 with materials to resist the migration of plasticizer thereinto or therethrough. In a preferred embodiment, the layer 33 is paper. A preferred multi-layer wrapper material is Cushion Foil Laminate from General Packaging. Quilted paper is available from Georgia Pacific. Both of the layers 32, 33 are food grade. Nicks or cuts 46 may be provided extending inwardly from a free edge 40 to permit tearing of the wrapper 5 to remove a section 41 to expose the shell 2 while having a portion of the wrapper remain for convenience and comfort of the consumer. The thickness, foldability and creasability of the wrapper 5 is such as to permit folding and creasing of the end portions thereof to enclose the end portions 35 of the shell 2 and filling 3 and have the folds and creases remain until a consumer opens the wrapper 5. Preferably, the wrapper 5 has a total thickness in the range of between about 0.001 and about 0.005 of an inch with a thickness of the aluminum foil being in the range of between about 0.00025 inches and about 0.002 inches and the remainder being the outer material 33. Paper is a preferred outer material 33, and permits for ease of printing material thereon and foldability. As seen in FIG. 1, the outer surface may be provided with an arrow or other direction indicator 37 to indicate to a worker how to properly place the food product 1 on the heating apparatus 10 to accommodate the free edge 40 of the outside portion of the wrapper 5 at the overlap 30.

In a preferred embodiment, when the food product 1 is to be rotated on rollers 14. The transverse cross sectional shape of the food product 1 is generally round. The cross sectional dimension of the food product 1, e.g., its diameter, is in the range of between about ½ inch and about 1½ inches. Further, the food product has a length in the range of between about 2 inches and about 8 inches. When the food component 4 is consumed, the wrapper 5 may provide for structural support for the contained food product to help maintain its structural integrity during the eating process.

The food components 4 have a weight in the range between about 1½ ozs. and about 8 ozs. and preferably in the range of about 3 ozs. and about 5 ozs.

After the manufacture of the food component 4, either before or after applying the wrapper 5, the food product may be cooled as by freezing or refrigeration and stored in that condition. The food component 4 may also be shelf stable. The food product 1 after manufacture and wrapping is preferably packaged in suitable shipping containers such as corrugated cardboard boxes.

To prepare the food product 1 for consumption, it is removed from its storage container and placed in the heating device 10, e.g., on and between two rollers 14. The product may be placed on the heating device in any of its possible storage conditions, frozen, refrigerated or a room temperature condition. It may be desirable in some cases, if the product is frozen, to allow the food component 4 to thaw prior to placing on the cooking device 10. The food component 4 with its wrapper 5 is heated to the appropriate temperature and may be maintained in the cooking device for extended periods of time, for example, several hours. When a consumer wants one of the food components 4, it may be removed from the cooking device 10 and provided to the consumer for eating either with a serving device such as a tray or plate and eating utensil or as a finger food, In many instances, the food component 4 will be consumed as a finger food by unwrapping only a portion of the wrapper 5 at a time from around the food component 4 or removing the section 41 allowing the wrapper 5 or a portion thereof to shield the consumer from direct contact with the food and to help provide structural integrity to the food component 4 during consumption and thermal insulation. It has been found that with the disclosed food product, that it can be frozen for distribution, heated as described and may be refrozen after holding on a roller grill for subsequent storage and then reheated while still providing acceptable quality.

Tamale product was prepared using the following formulas. The product has shown good stability during heating and provided good eating quality. The product was coextruded.

| Description | Weight | Percent |
|---|---|---|
| Beef (80% lean) | 63.00 | 63.00% |
| Water | 22.00 | 22.00% |
| Corn meal | 5.00 | 5.00% |
| Soy Protein Isolate | 5.00 | 5.00% |
| Seasoning Blend A | 3.00 | 3.00% |
| Ground Mustard | 1.50 | 1.50% |
| Salt | 0.50 | 0.50% |
| TOTAL | 100.00 | 100.00% |
| Corn meal | 32.27 | 32.27% |
| Beef Tallow | 3.07 | 3.07% |
| Seasoning Blend C | 3.33 | 3.33% |
| Water | 61.33 | 61.33% |
| TOTAL | 100.00 | 100.00% |

The finished product was 1.2 parts by weight filling and 1.8 parts by weight shell for a total of 3 parts by weight

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present invention will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method of preparing a wrapped food product:
providing a generally cylindrical food product including a filling with a side surface portion, a shell including at least one grain component enclosing at least the side surface portion of the filling and having an outer surface portion and a wrapper enclosing at least the outer surface portion of the shell and having overlapping edge margin portions; and
placing the food product on a roller grill and rotating the food product about a longitudinal axis thereof and heating the food product through the wrapper for a period of heating time sufficient to raise the temperature of the shell and filling to an eating temperature, said wrapper engaging rollers of the roller grill during heating.

2. The method of claim 1 wherein the wrapper having an inwardly facing metallic layer and an outwardly facing second layer.

3. The method of claim 2 wherein the outer layer being made of an absorbent material.

4. The method of claim 3 wherein the absorbent material including cellulose.

5. The method of claim 1 wherein the filling and shell being formed by co-extrusion.

6. The method of claim 5 wherein the shell being formed at least partially of masa.

7. The method of claim 6 wherein the filling and shell forming a tamale.

8. A wrapped food product adapted for heating on a roller grill, the food product including:
an elongate filling having an elongate first side surface portion and opposite first end portions, said filling including at least one of water and fat;
a shell having an elongate second side surface portion overlying and enclosing at least the first side surface portion of the filling, said shell including starch and protein derived from grain and at lease one plasticizer, said shell having a generally cylindrical side portion outer surface and opposite second end portions; and
a wrapper enclosing at least the shell side portion outer surface, said wrapper being substantially impermeable to said at least one plasticizer and having overlapping edge margin portions.

9. The food product of claim 8 wherein the grain including corn.

10. The food product of claim 9 wherein the shell being made of masa and is cooked.

11. The food product of claim 10 wherein the filling including meat.

12. The food product of claim 11 wherein the food product being a tamale.

13. The food product of claim wherein the wrapper being of a multi-layer construction including a paper layer secured to a metallic layer and being positioned on an outer disposed surface of the metallic layer.

14. The food product of claim 8 wherein the filling being a sweet filling.

15. The food product of claim 14 wherein the grain including a significant portion of wheat.

16. The food product of claim 8 wherein the wrapper having third end portions enclosing portions of the first and second end portions first and second.

17. The food product of claim 8 wherein the wrapper being of a multi-layer construction including at least two layers of material secured together in selected areas forming air pockets between at least two said layers.

18. The food product of claim 17 wherein at least one said layer being cellulosic.

19. The food product of claim 18 wherein at least two said layers being cellulosic.

20. The food product of claim 18 wherein at least two said layers being having a quilt pattern of areas of attachment to one another.
